(19) United States
(12) Patent Application Publication
(10) Pub. No.: US 2016/0267132 A1
(43) Pub. Date: Sep. 15, 2016

(54) ABSTRACTION LAYER BETWEEN A DATABASE QUERY ENGINE AND A DISTRIBUTED FILE SYSTEM

(71) Applicant: HEWLETT-PACKARD ENTERPRISE DEVELOPMENT LP, Houston, TX (US)

(72) Inventors: Maria G. Castellanos, Sunnyvale, CA (US); Qiming Chen, Cupertino, CA (US); Meichun Hsu, Los Alts Hills, CA (US)

(21) Appl. No.: 15/033,163

(22) PCT Filed: Dec. 17, 2013
(86) PCT No.: PCT/US2013/075651

§ 371 Date: Apr. 29, 2016

(51) Int. Cl. G06F 17/30

(52) U.S. Cl. CPC G06F 17/30457; G06F 17/3048; G06F 17/30132; G06F 17/30203; G06F 17/30233

(57) ABSTRACT

A system includes a distributed file system to control storage of data across storage nodes and a database query engine to receive a database query for access of data, the database query engine to process the database query using an index, and using a buffer pool to cache data retrieved in response to the database query and to store updated data. An abstraction layer is provided between the database query engine and the distributed file system, the abstraction layer to read and write data of the distributed file system in response to the database query.

### BACKGROUND

Data can be stored in relational tables of a relational database management system (RDBMS). A database query, such as a Structured Query Language (SQL) query, can be submitted to an RDBMS to access (read or write) data contained in relational table(s) stored in the RDBMS.

As the amount of data that is generated has become increasingly large, different data storage architectures have been proposed or implemented for storing large amounts of data in a computationally less intensive manner. An example of such a storage architecture for storing large amounts of data (also referred to as “big data”) is the Hadoop framework used for storing big data across a distributed arrangement of storage nodes.

### BRIEF DESCRIPTION OF THE DRAWINGS

Some embodiments are described with respect o the following figures.

FIG. 1 is a block diagram of an example arrangement according to some implementations.

FIG. 2 is a flow diagram of a process according to some implementations.

FIGS. 3 and 4 are block diagrams of example arrangements showing abstraction layers at different levels, according to some implementations.

FIG. 5 is a block diagram of a distributed arrangement of computing nodes in which some implementations can be provided.

### DETAILED DESCRIPTION

Although storage architectures designed for storing “big data” allows for storage of relatively large amounts of data in a manner that consumes less computation resources than traditional relational database management systems (RDBMS), such big data storage architectures may be associated with various issues. “Big data” can refer to any relatively large collection of data that may not be practically stored and processed by traditional RDBMS.

An example of a storage architecture for storing and processing big data is the Hadoop framework, which is able to store a collection of data across multiple storage nodes. An issue associated with the Hadoop framework is that a programming interface to a Hadoop storage system (a storage system according to the Hadoop framework) may be inconvenient and not user-friendly. The programming interface to a Hadoop storage system can be according to a MapReduce programming model, which includes a map procedure and a reduce procedure. A map procedure specifies a map task, and a reduce procedure specifies a reduce task, where the map and reduce tasks are executable by computing nodes used for storing a collection of data. Map tasks specified by the map procedure process corresponding segments of input data to produce intermediate results. The intermediate results are then provided to reduce tasks specified by the reduce procedure. The reduce tasks process and merge the intermediate values to provide an output.

The map and reduce procedures can be user-defined functions. Having to develop map and reduce procedures for accessing data stored by the Hadoop storage system adds a layer of complexity to the programming interface for the Hadoop storage system.

A further issue associated with a Hadoop storage system is that the Hadoop storage system is suitable for analytical database applications, but not for operational database applications. An analytical database application refers to a database application that performs processing of a collection of data for analysis purposes; such an application can be performed in an offline manner, such as in batch jobs executed during off-peak time periods.

In contrast, operational database applications are online applications that perform processing of a collection of data in response to queries for the data, where the responses to the queries are provided to requesting entities in an online manner. In other words, the responses are provided back to the requesting entities within a target time interval from receipt of the queries, while the requesting entities remain online with respect to the data processing system that processes the queries. A target time interval during which a response is expected to be returned in response to a query can be governed by a service level agreement (SLA) or another target goal specified for an operational database application. In some examples, an operational database application includes real-time On-Line Transaction Processing (OLTP), which involves inserting, deleting, and updating of data for transactions in real-time in response to requests from requesting entities, which can include users or machines. Obtaining results for transactions in “real-time” can refer to obtaining results while a requesting entity that submitted the transactions remains online with respect to the data processing system and waits for the results, where the requesting entity expects the results to be returned within some expected time interval.

An RDBMS, also referred to as a “relational database system,” provides a more user-friendly programming interface and is able to support operational database applications. The programming interface of a relational database system can include a database query interface, such as a Structured Query Language (SQL) query interface that allows users or machines to submit SQL queries to the database system to access data stored in relational tables of the database system. The syntax of SQL queries is well defined, and database users are familiar with SQL queries.

Experienced database users can formulate SQL queries to perform many different operations on a collection of data, where the operations can include data insert operations, data delete operations, data update operations, data join operations (where data of two or more relational tables can be joined), data merge operations, and so forth.

An issue associated with a relational database system is that the relational database system may not be able to effectively store and process a large amount of data without deployment of large amounts of computation resources. Thus, it may not be practical to use traditional relational database systems for storing a large collection of data.

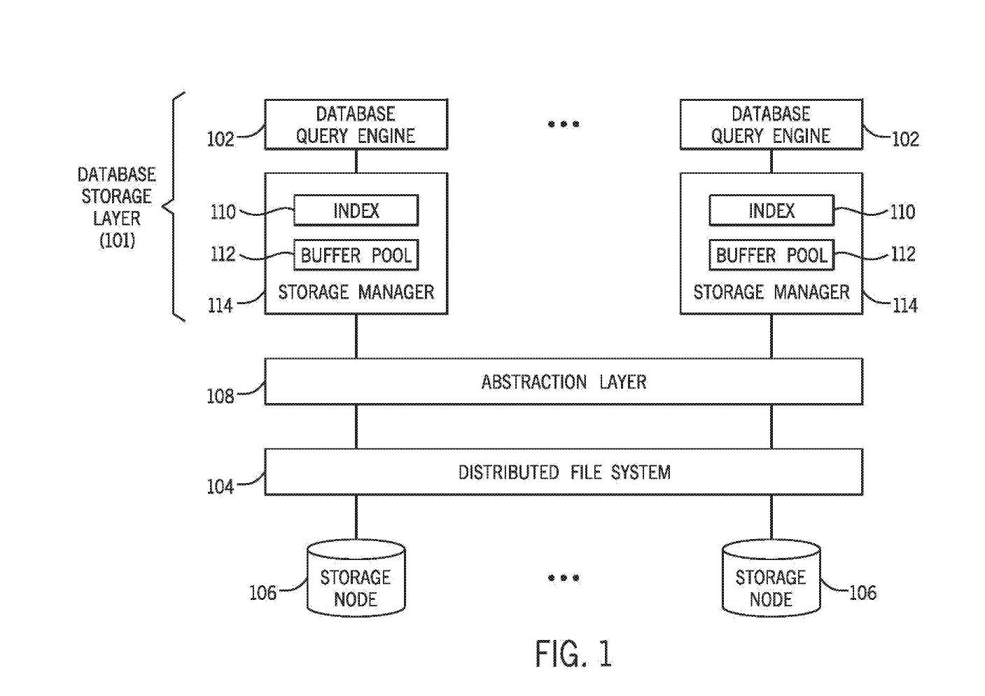

In accordance with some implementations, a hybrid data storage arrangement is provided that combines query processing features of a relational database system with storage features of a big data storage architecture. FIG. 1 shows an example hybrid data storage arrangement according to some implementations. The hybrid data storage arrangement of FIG. 1 includes database query engines 102 and a distributed file system 104. The database query engines 102 are to receive database queries (e.g. SQL queries) that perform operations on data. The distributed file system 104 controls storage of data across storage nodes 106. The distributed file system 104 can be the distributed file system of a big data storage architecture, which is able to efficiently store and access a large collection of data. An example of the distributed file system 104 is a Hadoop Distributed File System (HDFS). In other examples, the distributed file system 104 can be another type of file system, such as a Ceph File System.

The hybrid data storage arrangement further includes an abstraction layer 108 between the database query engines 102 and the distributed file system 104. The abstraction layer 108 is able to read and write data of the distributed file system in response to a database query received by a database query engine 102.

The hybrid data storage arrangement of FIG. 1 is a distributed storage arrangement that can be deployed across multiple computing nodes. A computing node can include a processor or multiple processors. A computing node can include a respective database query engine 102, along with respective portions of the abstraction layer 108 and the distributed file system 104. Each computing node is able to access a respective storage node 106.

Operational database applications, such as real-time OLTP, can be supported by the hybrid data storage arrangement of FIG. 1 by use of features of a relational database system that make data operations more efficient. Such features include an index 110 and a buffer pool 112. In the distributed arrangement of FIG. 1, each database query engine 102 is associated with a respective storage manager 114 that contains entities for managing a respective index 110 and buffer pool 112. By leveraging the use of indexes 110 and buffer pools 112 (as well as other features of a relational database system), both read access and write access of data in the storage nodes 106 can be performed on a real-time basis. Note that operational database applications are often update-oriented, with transactions that frequently update data. Use of indexing and buffer pools can allow for data updates to be performed more quickly.

The database query engines 102 and storage managers 114 are part of a database storage layer 101. The database storage layer 101 also includes other features available from relational database systems. For example, the database storage layer 101 can include a query optimizer, which is able to develop a query plan for performing operations on data in response to receiving a database query. The query plan can specify various operations to be performed, including, as examples, a read operation, a join operation, a merge operation, an update operation, and so forth. In response to a database query, the query optimizer can develop several candidate query plans for executing the database query, and can select the best (in terms of operation speed, efficiency, etc.) from among the candidate query plans to use.

The database storage layer 101 can also implement concurrency control, which ensures that there are not inconsistent operations being performed on data that is being concurrently accessed in a distributed arrangement. For example, concurrency control can ensure that two concurrent operations do not write different values to the same data record.

Although the abstraction layer 104 is depicted as being outside of the database storage layer 101 in FIG. 1, it is noted that in some implementations, the abstraction layer 104 can be part of the database storage layer 101 (discussed further below).

An index 110 is defined on one or multiple attributes. A data record can include multiple attributes. For example, a data record stored by an enterprise (e.g. business concern, government agency, educational organization) can include the following attributes: employee identifier, employee name, department name, job role, manager, etc. An index maps different values of at least one attribute to different locations that store data containing the respective values of the at least one attribute. For example, if an index is defined on an employee identifier, then the index can map each unique value of the employee identifier to respective location(s) that store data records that contain the unique value of the employee identifier. In response to a database query, a database query engine 102 is able to identify at least one location storing data responsive to the database query by accessing the index. In some examples, the indexes 110 can be B-tree indexes, or other types of indexes.

Using the indexes 110 for processing database queries improves query processing efficiency, since locations storing requested data can be identified by accessing the indexes 110, without having to scan data stored at the storage nodes 106 (which can take a relatively long time due to the large amount of stored data and the relatively slow access speeds of the persistent storage media used to implement the storage nodes 106). Also, by using the indexes 110, multiple concurrent data retrieval tasks can have random access to requested data.

A buffer pool 112 can include one or multiple buffers for caching recently read data (data retrieved from a storage node 106, which can be implemented with persistent storage media, such as disk-based media or persistent solid state media). A first access of data causes the data to be cached in the buffer pool 112. A subsequent read of the same data can be satisfied from the buffer pool 112. If a buffer pool 112 becomes full, then a replacement technique can be used to evict data from the buffer pool 112. For example, the replacement technique can be a least recently used (LRU) technique, in which a least recently used data is evicted from the buffer pool 112. In other examples, other replacement techniques can be used.

The buffer pool 112 can also include one or multiple buffers that implement(s) a write-ahead-log that stores updated data. For example, a database query can cause the writing of data (e.g. inserting a new data record or updating a data record). The data updated by the write can be stored in the write-ahead-log, without immediately writing the updated data (also referred to as “dirty data”) to persistent storage media of the storage nodes 106. Dirty data evicted from the buffer pool 112 can be synchronized to the distributed file system 104 (to update the respective data stored in the corresponding storage node(s) 106), and the corresponding entry in the write-ahead-log can be removed.

The buffer pool 112 can be implemented in higher-speed memory, which can be accessed more quickly than the persistent storage media of the storage nodes 106.

As shown in FIG. 1, the buffer pools 112 are arranged in a distributed manner. In some examples, the buffer pools 112 can be according to a distributed caching system, such as the Memcached system or some other type of caching system. In response to a query, a database query engine 102 can identify a location of the requested data, and a page (also referred to as a “block”) containing the requested data. The page can be identified by a page identifier (ID). The distributed caching system can first check if the page identified by the page ID exists in the distributed arrangement of buffer pools 112, and if so, the page is read from the buffer pools 112. If not, the page is requested from the distributed file system 104.

The distributed file system 104 does not support use of the indexes 110 and buffer pools 112. Accordingly, without the database storage layer 101 (including the database query engines 102 and storage managers 114), the distributed file system 104 would not be able to support data operations at a sufficiently high throughput to support operational database applications. However, by tying together the database storage layer 101 and the distributed file system 104 using the abstraction layer 108, an arrangement that provides the computation efficiency of the distributed file system 104 and advanced features of the database storage layer 101 can be provided. The distributed file system 104 can offer scalability (to allow the capacity of the distributed storage system to be expanded easily), reliability (to provide reliable access of data), and availability (to provide fault tolerance in the face of machine faults or errors). The advanced features of the database storage layer 101 include index management, buffer pool management, query optimization, and concurrency control.

In specific examples, the hybrid data storage arrangement includes an operational SQL-on-Hadoop arrangement (which includes a database query engine that supports SQL queries and a HDFS).

In accordance with some implementations, by using the abstraction layer 108, customization of the database storage layer 101 for use with the distributed file system 104 does not have to be performed. From the perspective of the database storage layer 101 the storage system that stores data appears to be that of a relational database system. As a result, substantial re-engineering of the database storage layer 101 does not have to be performed.

As discussed further below, the abstraction layer 108 can be provided at any one of several levels of the hybrid data storage arrangement above the distributed file system 104. The abstraction layer 108 can also be referred to as a virtual file system (VFS).

The abstraction layer 108 allows a client (e.g. the database storage layer 101) to access different types of physical file systems (e.g. HDFS, Ceph File System) in a uniform way. For example, the abstraction layer 108 can access local and network storage devices transparently without the client noticing the difference. The abstraction layer 108 can bridge applications with physical file systems, to allow applications to access files without having to know about the behavior of file system they are accessing. Also, the presence of the abstraction layer 108 allows for support of new types of distributed file systems in the hybrid data storage arrangement without having to modify the database storage layer 101. The abstraction layer 108 abstracts the distributed file system by hiding details of the distributed file system from the database query engines 102.

The abstraction layer 108 also allows interaction between the database query engines 102 and the distributed file system 104 without bypassing certain features (such as the indexes 110 and buffer pools 112) of the database storage layer 101. For example, in some examples, the database query engines 102 may be modified to access the interface (in the form of an application programming interface or API, for example) of the distributed file system 104. In such examples, the indexing and buffer pool features of the database storage layer 101 would be bypassed.

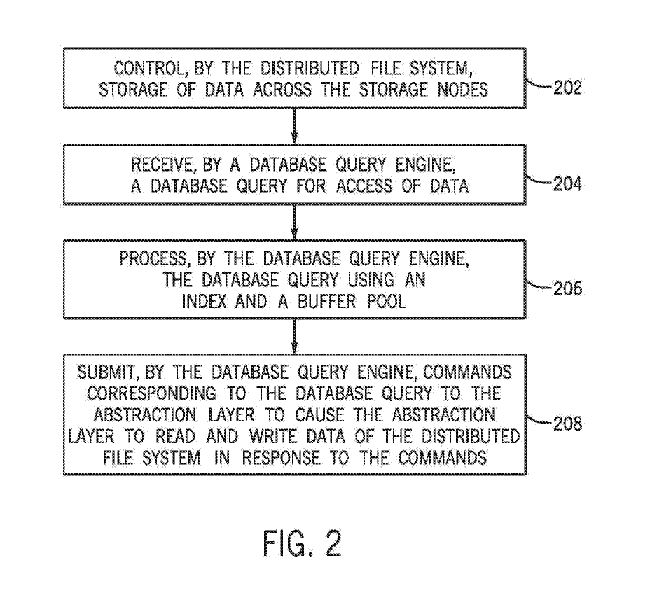

FIG. 2 is a flow diagram of a process according to some implementations, which can be implemented in the hybrid data storage arrangement of FIG. 1, for example. The distributed file system 104 controls (at 202) storage of data across the storage nodes 106. As noted above, the distributed file system 104 controls the storage of data without using the indexes 110 and without using the buffer pools 112 that store updated data and that cache data retrieved in response to a data request.

A database query engine 102 receives (at 204) a database query for access of data. The database query engine 102 processes (at 206) the database query using an index 110, and using a buffer pool 112. The database query engine 102 then submits (at 208) commands corresponding to the database query to the abstraction layer 108 to cause the abstraction layer 108 to read and write data of the distributed file system 104 in response to the commands.

The commands are provided by the database query engine 102 based on a query plan produced by a query optimizer of the database storage layer 101. The commands can include a command to insert data, a command to delete data, a command to update data, a command to join data, a command to merge data, and so forth.

As noted above, the abstraction layer 108 can be provided at one of several levels above the distributed file system 104. In some implementations, the abstraction layer 108 can be included in just the database storage layer 101. More specifically, the abstraction layer 108 can be part of the storage manager 114 level in FIG. 1. In alternative implementations, the abstraction layer 108 can be provided below the database storage layer 101.

In the ensuing discussion, it is assumed that the distributed file system 104 is the HDFS, and that an HBase database is implemented on the HDFS. HBase refers to an open source, non-relational distributed database that stores data in HBase tables. Although a specific database architecture (HBase) and distributed file system (HDFS) is assumed in the ensuing discussion, it is noted that techniques or mechanisms according to some implementations can be applied to other types of database architectures and distributed file systems.

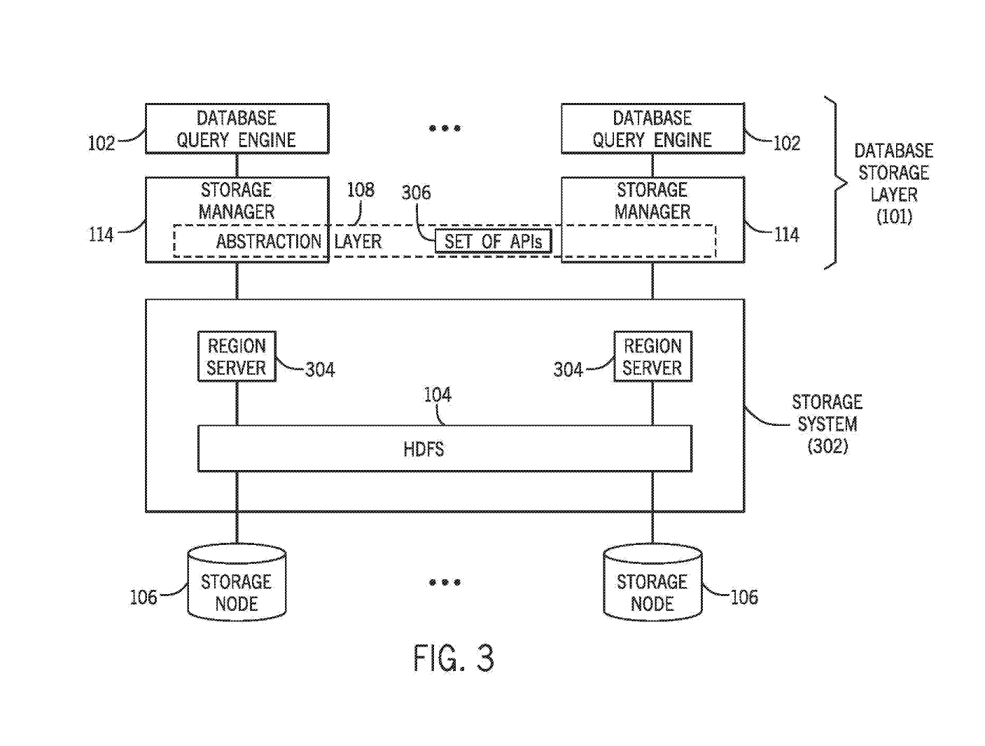

FIG. 3 is a block diagram of an example arrangement in which the abstraction layer 108 is implemented at the level of the storage managers 114. In a storage system 302 as shown in FIG. 3 that implements HBase, an HBase table is split horizontally into multiple regions, which are accessed by respective region servers 304 that can reside on different computing nodes. Each region server 304 is able to manage access of multiple HBase table regions, with each region belonging to a respective HBase table.

In accordance with some implementations, the abstraction layer 108 is abstracted at the page level to allow page access of data stored in the storage system 302. A page (also referred to as a “block”) can refer to a container of data having a specified size. An HBase database is implemented as a key-value store. In a key-value store, each database record has a primary key and a collection of one or multiple values. In accordance with some implementations, the abstraction layer 108 of FIG. 3 provides an interface (which can include a set of APIs 306, for example) in which a page ID (also referred to as a block number) can be used as the key for the HBase key-value store, and the content of the page constitutes the value(s). An API refers to a code that can be invoked by a requesting entity to access another component. Different APIs in the set of APIs 306 can be used to perform different operations, such as read, write, etc.

In the FIG. 3 arrangement, the data records of the HBase database stores pages that can be accessed using the set of APIs of the abstraction layer 108. The set of APIs 306 include page access APIs that enable access of the key-value data stores of the HBase database. The set of APIs 306 can be implemented using the key-value APIs of an HBase database system.

The set of APIs 306 can be invoked in response to commands from the database query engine 102 that are generated in response to a database query. The commands access respective pages, whose page IDs are provided in the invocation of APIs from the set 306. Invocation of the APIs from the set 306 causes the abstraction layer 106 to produce further commands that are submitted to the storage system 302 to access respective data records of the HBase database using page IDs as keys.

An HBase table region managed by a region server 304 can be further split into respective portions that are stored as files of the HDFS 104. The files of the HDFS 104 are referred to as HFiles.

Each region server 304 can also include a local buffer pool for buffering portions of an HFile that has been retrieved from a storage node 306. In addition, an updated portion of an HFile can be logged to a local write-ahead-log of the region server 304. Dirty data of the local write-ahead-log of the region server 304 can be synchronized with the HDFS 104.

The local buffer pool and local write-ahead-log of each region server 304 are similar to the respective buffer pool 112 of a corresponding storage manager 114 (discussed above). In the arrangement of FIG. 3, dirty data in the buffer pool 112 of the storage manager 114 in the database storage layer 101 is not synchronized directly to the HDFS 104, but instead is first provided to the local write-ahead-log of a region server 304 before synchronization with the HDFS 104.

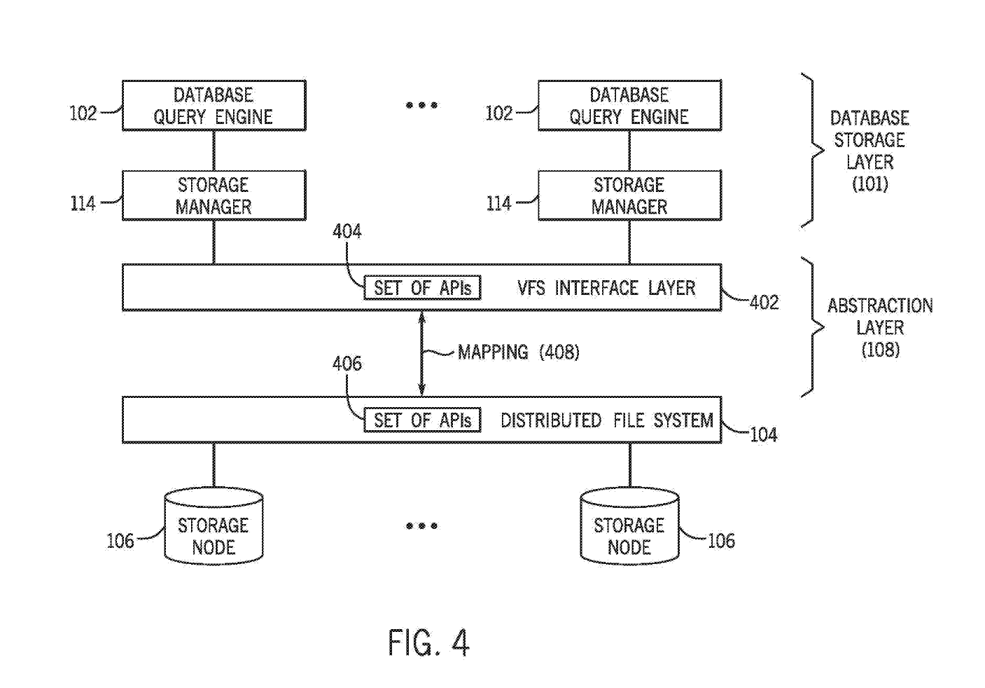

FIG. 4 illustrates implementation of the abstraction layer 108 at a different level. In FIG. 4, the abstraction layer 108 is implemented with a VFS interface layer 402 that is below the database storage layer 101. The VFS interface layer 402 includes a set of APIs 404 accessible by the database storage layer 101. The set of APIs 404 handle data accesses at the page level.

The set of APIs 404 in the VFS interface layer 402 are mapped to a set of APIs 406 of the distributed file system 104, using a mapping 408 that is also part of the abstraction layer 108. The mapping can be in the form of various procedures that translate page accesses due to invocation of the set of APIs 404 in the VFS interface layer 402 to accesses of data at a different granularity (smaller blocks or larger blocks) as provided by the set of APIs 406 of the distributed file system 104.

In response to a query received by a database query engine 102, the database query engine 102 produces commands to access data. These commands cause invocation of API(s) of the set of APIs 404 in the VFS interface layer 402. The invoked API(s) are mapped by the mapping 408 to respective API(s) of the set of the APIs 406 in the distributed file system 104. The mapped API(s) of the set of APIs 406 is (are) executed to access data in the storage nodes 106.

Further details regarding the buffer pools 112 discussed in connection with FIG. 1 are provided below. A buffer pool 112 can be implemented as a shared in-memory data structure, such as an array of pages (or blocks). A page in the buffer pool 112 is used to buffer a block of data in the corresponding storage system, and is identified by a tag or page ID.

The buffer pool 112 can be accompanied by a corresponding array of data structures referred to a buffer descriptors, with each buffer descriptor recording information about a corresponding page (e.g. the page's tag, the usage frequency of the page, the last access time of the page, whether the page is dirty (updated), and so forth.

When a process of a database query engine 102 requests access of a specific page, if the block is already cached in the buffer pool 112, then the corresponding buffered page is pinned (the page is locked to prevent another process from accessing the page). If the page is not cached in the buffer pool 112, then it is determined if a free page slot exists in the buffer pool 112 for storing the page. If there are no slots free, the process selects a page to evict from the buffer pool 112 to make space for the requested page. If the page to be evicted is dirty, the dirty page is written to the distributed file system 104.

Deciding which page to remove from the buffer pool to make space for a new page can use a replacement technique such as an LRU technique. A timestamp when each page was last used is kept in the corresponding buffer descriptor in order for the system to determine which page is least recently used. Another way to implement LRU is to keep pages sorted in order of recent access. In other examples, other types of replacement techniques can be used.

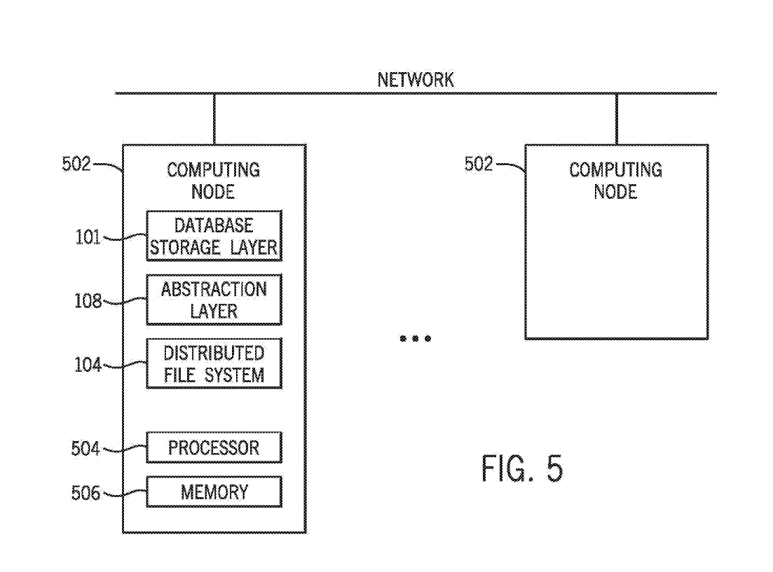

FIG. 5 is a block diagram of an example arrangement of computing nodes 502, which can be used to implement a hybrid data storage arrangement as discussed above. As shown in FIG. 5, each computing node 502 includes the database storage layer 101, the abstraction layer 108, and the distributed file system 104. Also, each computing node 502 includes one or multiple processors 504 and memory 506. A processor can include a microprocessor, microcontroller, processor module or subsystem, programmable integrated circuit, programmable gate array, or another control or computing device.

The memory 506 can be implemented as one or multiple non-transitory computer-readable or machine-readable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A system comprising:
a distributed file system to control storage of data across storage nodes;
a database query engine to receive a database query for access of data, the database query engine to process the database query using an index, and using a buffer pool to cache data retrieved in response to the database query and to store updated data; and
an abstraction layer between the database query engine and the distributed file system, the abstraction layer to read and write data of the distributed file system in response to the database query.

2. The system of claim 1, wherein the distributed file system is without support for use of the index and the buffer pool for accessing the data stored in the storage nodes.

3. The system of claim 2, wherein the received database query is a Structured Query Language (SQL) query.

4. The system of claim 1, wherein the received database query is for an operational database application that supports real-time transactions on the data stored in the storage nodes, the real-time transactions to insert data, delete data, and update data in the storage nodes.

5. The system of claim 1, wherein the abstraction layer includes a virtual file system (VFS) that abstracts the distributed file system, the VFS to hide details of the distributed file system from the database query engine.

6. The system of claim 1, further comprising a database storage layer that includes the database query engine and a storage manager to manage the index, wherein the storage manager is to update the index in response to storing of data with new values of at least one attribute on which the index is defined, wherein the index maps different values of the at least one attribute to different locations that store data containing the respective values of the at least one attribute, and wherein the database query engine is to identify at least one location storing data responsive to the database query by accessing the index.

7. The system of claim 1, further comprising a database storage layer that includes the database query engine and a storage manager to manage the buffer pool that includes one or multiple buffers, and wherein the database query engine is to determine whether the buffer pool contains data responsive to a subsequent database query.

8. The system of claim 7, wherein the database query engine is to further:
determine a page identifier corresponding to data requested by the subsequent database query,
determine whether a page identified by the page identifier is in the buffer pool, and
read the page from the buffer pool if the page is determined to be in the buffer pool.

9. The system of claim 7, wherein the abstraction layer is part of the database storage layer.

10. The system of claim 1, wherein the distributed file system is selected from among a Hadoop file system and a Ceph file system.

11. The system of claim 1, wherein the abstraction layer includes a set of application programming interfaces (APIs) and a mapping between the set of APIs and corresponding APIs of the distributed file system.

12. A method comprising:
controlling, by a distributed file system, storage of data across storage nodes, wherein the distributed file system controls the storage of data without using an index and without using a buffer pool to cache data retrieved in response to a data request and to store updated data;
receiving, by a database query engine, a database query for access of data;
processing, by the database query engine, the database query using the index, and using the buffer pool, the index and the buffer pool being part of a database storage layer that includes the database query engine; and
submitting, by the database query engine, commands corresponding to the database query to an abstraction layer between the database query engine and the distributed file system, the abstraction layer to read and write data of the distributed file system in response to the commands.

13. The method of claim 12, wherein the distributed file system is part of a storage system that stores data in key-value stores, the abstraction layer including a set of application programming interfaces (APIs) that use identifiers of pages as keys for the key-value stores.

14. The method of claim 12, wherein the abstraction layer includes a set of application programming interfaces (APIs) to access data at a page level, and a mapping to map the set of APIs to APIs of the distributed file system.

15. An article comprising at least one non-transitory machine-readable storage medium storing instructions that upon execution cause a system to:
control storage of data across storage nodes by a distributed file system;
receive, by a database query engine, a database query for access of data;
process, by the database query engine, the database query using an index, and using a buffer pool to cache data retrieved in response to the database query and to store updated data; and
in response to the processing, issue commands to an abstraction layer between the database query engine and the distributed file system, to cause the abstraction layer to read and write data of the distributed file system in response to the database query.
